(19) United States
(12) Patent Application Publication
(10) Pub. No.: US 2008/0201842 A1
(43) Pub. Date: Aug. 28, 2008

(54) Transfer Device

(75) Inventor: Colin Quickmire, York (GB)

Correspondence Address: SHUMAKER & SIEFFERT, P. A., 1625 RADIO DRIVE, SUITE 300, WOODBURY, MN, 55125, US

(73) Assignee: Quintal Healthcare Limited, West Yorkshire (GB)

(21) Appl. No.: 11/910,846

(22) PCT Filed: Apr. 10, 2006
(86) PCT No.: PCT/GB06/01293

§ 371 Date: Nov. 28, 2007

(30) Foreign Application Priority Data
Apr. 8, 2005 (GB) 0507155.0

(51) Int. Cl. A61G 7/10

(52) U.S. Cl. 5/81.1 HS

(57) ABSTRACT

A transfer device transfer device for facilitating transfer of a person from one seating position to another, the device comprising an arcuate board at least a main part of which is curved through an angle of at least substantially 70°.

### BACKGROUND

The invention relates to devices for transferring persons between seating locations. In particular the invention relates to devices for transferring persons between seating locations by sliding across a board.

### BRIEF SUMMARY OF THE DISCLOSURE

The problem of transferring a person between seating locations when the person lacks mobility is well known, particularly in hospitals, nursing homes and situations involving the ambulance services. Transfer of a person by manual manipulation typically requires a number of people to lift the person. The manual lifting process is a common source of injury to persons such as hospital staff as well as the person being lifted, and is therefore highly undesirable.

It is known to use a variety of hoist devices to lift and transfer people from one seating location to another, for example in hospitals. However, hoists are expensive and not readily portable. The problem often arises that a hoist is not available when it is required to transfer a person. Typical situations include transfer between a wheelchair and a vehicle, or between a bed and a wheelchair or between a wheelchair and toilet in a domestic environment.

To address this problem, a transfer board may be used. A transfer board typically comprises an elongate board that may be suspended between seating locations. A person may be transferred between seating locations by using the transfer board to bridge the gap between the locations. The person may then be transferred between the locations by a sliding or shuffling motion along the board.

Known transfer boards suffer the problem of having a limited weight capacity. This is a consequence of the requirement of a low weight for portability, and a low profile (thickness) to enable people to be readily transferred to and from the board. In addition, in the case of people severely lacking in mobility, a substantial effort is required to move the person along the length of the board.

U.S. Pat. No. 5,193,233 discloses a curved patient transfer unit having a plurality of rollers to ease transfer of a patient along the board. The unit suffers the disadvantage that it comprises a plurality of rotating mechanical components that may wear or fail in use. Furthermore, clothing and other items can become trapped in the rollers.

U.S. Pat. No. 5,282,284 discloses a curved sliding transfer device having a seat that can slide across a top surface of the device. The unit suffers the disadvantage that the mechanical sliding mechanism may fail in use. Furthermore, items of clothing or exposed areas of skin may become trapped in the device leading to inconvenience and potential discomfort to a user.

U.S. Pat. No. 5,966,754 discloses a sliding device for translating patients in a straight line direction from a first location to a second location with an endless band wrapped around a fluid-filled body in the form of a board. The unit suffers the disadvantage that an orientation of a patient on the board is not changed following translation along the board. Furthermore, the board is apparently of relatively complex construction and costly to produce.

GB2212401 and GB2343620 both disclose patient transfer boards along which patients to be transferred may slide. However the boards are designed for the transfer of patients in a lying position, rather than a seated position. The boards are therefore not suitable for transferring patients between a seated position in a first location and a seated position in a second location.

According to the present invention there is provided a transfer device for facilitating. transfer of a person from one seating position to another, the device comprising an arcuate board at least a main part of which is curved through an angle of at least substantially 70°.

By the term ‘curved through an angle of at least substantially 70°’ is meant that a notional longitudinal axis of the device is curved through an angle of at least substantially 70°.

The advantage of the device is that a person may be turned through an angle conveniently and comfortably by sliding along a length of the board. Thus, a person in a wheelchair wishing to transfer from a wheelchair to a seat directly in front of them may be conveniently manipulated whilst remaining in an upright seated position. For example, a face to face transfer from, say, a wheelchair to a toilet seat directly facing them may be made. Additionally, a transfer from a wheelchair to a seat of a car directly in front of the wheelchair may be made.

At least two situations in which use of the device may be contemplated are as follows. A first situation involves movement of a person who is severely lacking in mobility. The person may be manipulated onto an end of the board such that the person's legs protrude over the inner radial edge of the device. The person may then be swung along the length of the board, in stages, using the person's feet as a pivot point.

In a second situation, the arcuate shape of the board may be used to negotiate obstacles between the seating locations, with the person's legs protruding over either an inner radial edge or an outer radial edge of the board. Obstacles may include vehicle doors, items of furniture, or wheels of a wheelchair. Alternatively, a person's legs could straddle the board during a transfer.

Since the device is curved through a greater angle than devices disclosed in the prior art such as U.S. Pat. No. 5,193,233, face to face transfers are possible. Furthermore, a device according to the present invention does not require the presence of rollers to assist a patient in translating from one end of the device to the other.

In addition, the curvature of a device according to the present invention may be made greater than that of the device of U.S. Pat. No. 5,193,233. Since a device according to the disclosure of U.S. Pat. No. 5,193,233 requires the presence of a plurality of spaced apart rollers, a limit exists to the amount of curvature the device may be formed with. As the amount of curvature is increased, a gap between rollers at an outer edge of the device also increases. As the size of the gap becomes larger, the level of discomfort suffered by a patient being transferred will increase, together with a risk of items including limbs becoming trapped between rollers of the device. Conversely, a device according to the present invention may be made in a relatively compact manner.

By varying a size and scale of a device according to the present invention, a strength and weight of the device may be varied. The device may be made stronger by making a thickness of the device greater for a given length of the device.

Preferably the device comprises curved end portions, said end portions being provided at longitudinally opposed ends of the main part of the body.

This feature has the advantage that a transition on to the board by the patient may be made comfortably and conveniently since the curved portions facilitate placement of an edge of the board under a portion of a patient's body without risk of injury or discomfort.

Preferably said end portions are substantially semicircular in plan view.

This feature has the advantage of further increasing an ease of manipulation of the device in relation to a patient's body.

Preferably at least a portion of a perimeter of the device is of a tapered or chamfered cross-section, said portion being configured to allow a patient to slide on to or off the device.

This feature has the advantage of yet further increasing the ease of manipulation of the device in relation to a patient's body.

Preferably the perimeter of the device at one of said ends comprises a tapered or chamfered portion.

The device may be provided with gripping means on an underside of the device, the gripping means being configured to grip a surface underlying the device.

This feature has the advantage of reducing the risk of slippage of the device with respect to a surface underlying the device, such as a portion of a wheelchair seat, when the device is in a bridging position between seating locations.

Preferably the gripping means comprises at least one grip pad. A grip pad may be provided at each end of the device. This feature has the advantage that one grip pad may contact a surface from which a person is to be transferred, and a second grip pad may contact a surface to which the person is to be transferred.

Preferably the grip pad comprises a polymeric material. The polymeric material may comprise a resilient polymeric material. Preferably the polymeric material comprises a rubber material.

Preferably the grip means is mounted in a recess of the device. This feature has the advantage that the grip means is less susceptible to detachment from the board when the grip means is subjected to lateral forces.

Preferably a major face of the device comprises at least one rib, the rib being configured to increase a failure strength of the board.

Preferably a transition region is provided between the rib and a portion of the board adjacent the rib, the transition region being provided with a curved profile, said curved profile being configured to facilitate cleaning of the board.

The device may have at least one handle, the handle being configured to allow the device to be conveniently carried by a person.

Preferably the at least one handle is formed integrally with the board.

The at least one handle may comprise an aperture formed in a face of the board. The aperture may be elongate.

Preferably the handle is formed in a portion of the board between a middle region of the board and an end of the board, the handle comprising an aperture through the board.

The handle may be formed proximate a perimeter of the device.

Preferably the device comprises two major edges, the major edges being substantially mutually parallel.

Preferably the main portion of the board is curved through an angle of between substantially 70° and substantially 180°.

The main portion of the board may be curved through an angle of between substantially 90° and substantially 120°.

More preferably, the main portion of the board is curved through an angle of substantially 100°.

In some embodiments, the device may take the general form of a part section of a circle, for example between an eighth of a circle and a semicircle.

The device may further be provided with an antimicrobial agent. The antimicrobial agent may be a silver-based antimicrobial agent, or any other suitable bacteriocidal or bacteriostatic material. The antimicrobial agent helps to maintain a germ-free environment at the surface of the device. The antimicrobial agent may be in the form of a coating of the device, or be mixed with a plastics or other material from which the board is fabricated. This has the advantage over a coating that, as the device wears, further antimicrobial agent is exposed. Antimicrobial protection is therefore retained at the surface throughout the life of the device.

Preferably, the board is fabricated from a talc-filled polypropylene plastics material.

Provision of the handle aperture in the stated location enhances the failure strength of the device. Preferably, the aperture runs substantially parallel to an edge of the device. The handle may be formed with a curved, oblong profile, the curved profile reducing any propensity of the material to crack in the region of the handle.

For a better understanding of the present invention, and to show how it may be carried into effect, reference shall now be made by way of example to the accompanying drawings, in which:

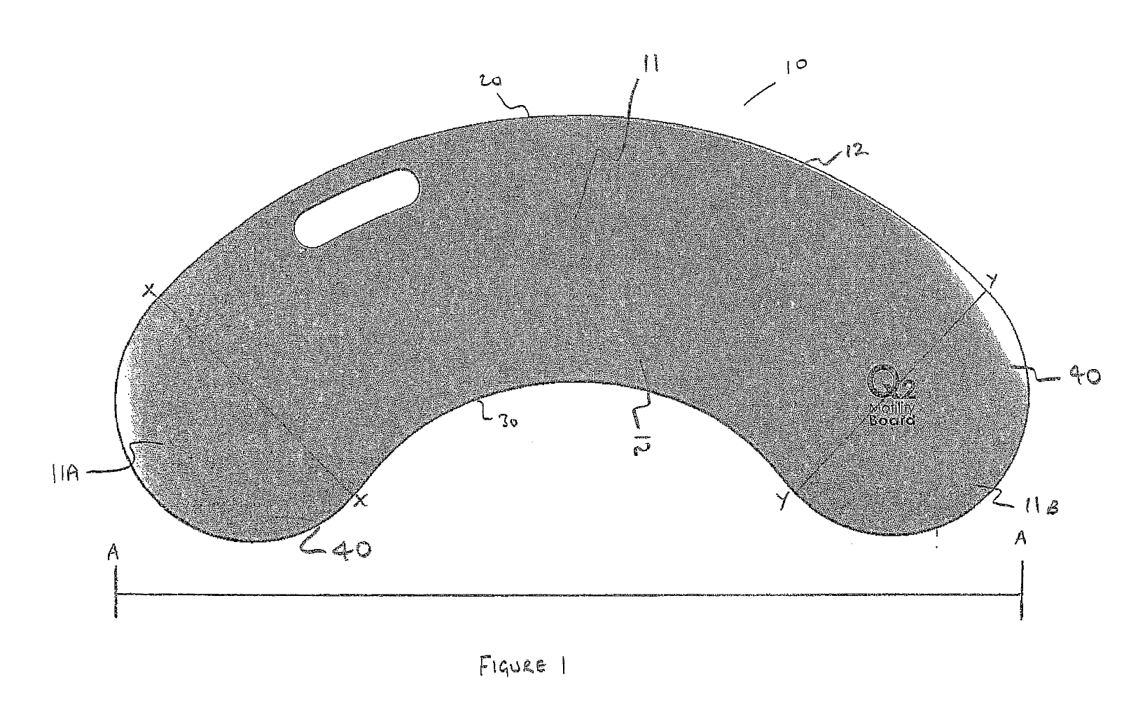

FIG. 1 is a plan view of a transfer device according to the first embodiment;

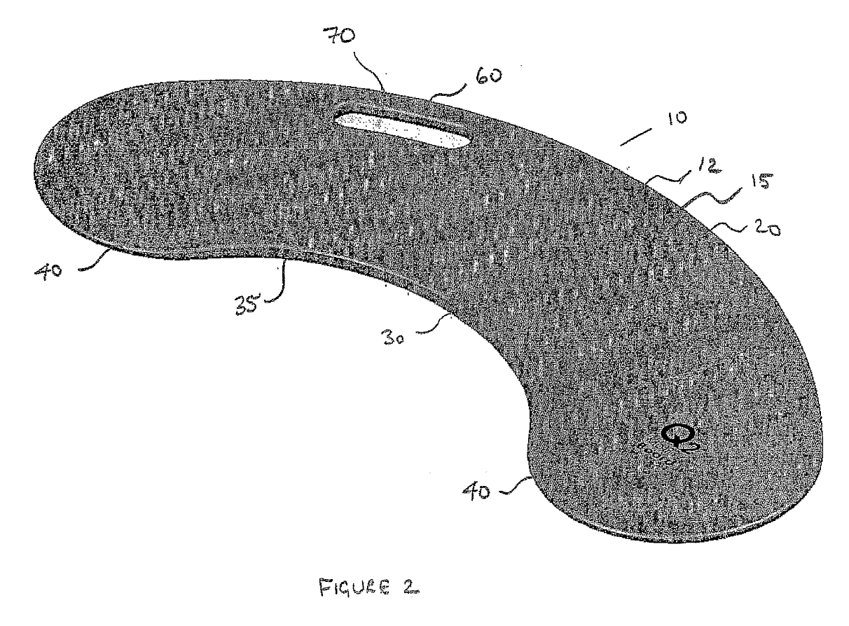

FIG. 2 is a perspective view of a transfer device according to the first embodiment;

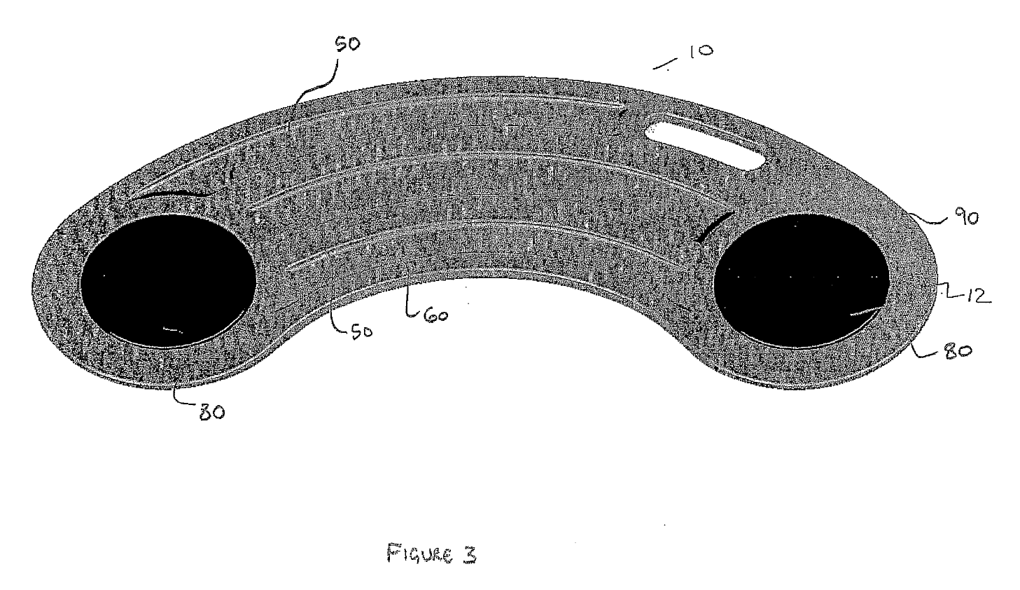

FIG. 3 is a perspective view of the underside of a transfer device according to the first embodiment;

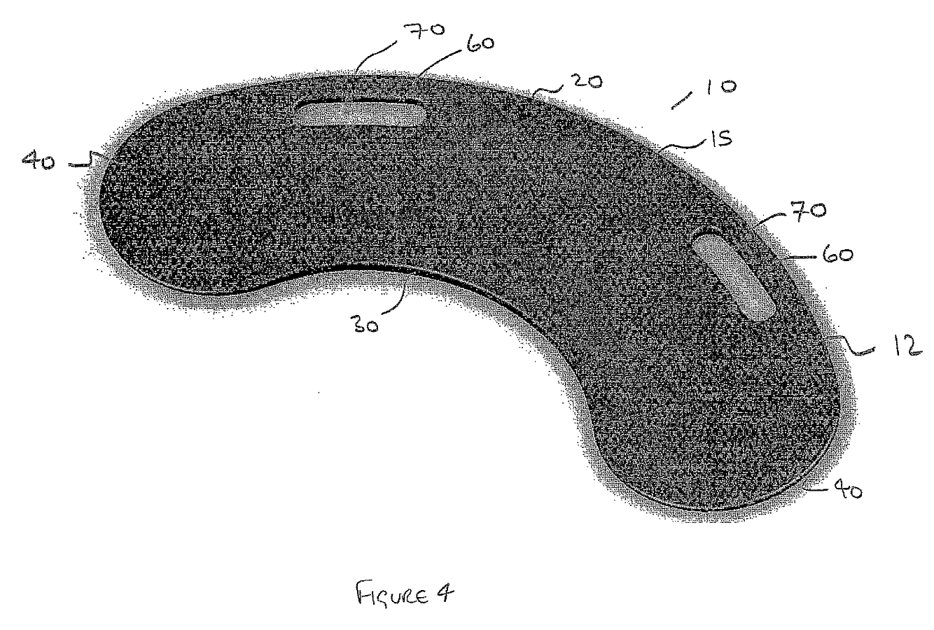

FIG. 4 is a perspective view of a transfer device according to a second embodiment;

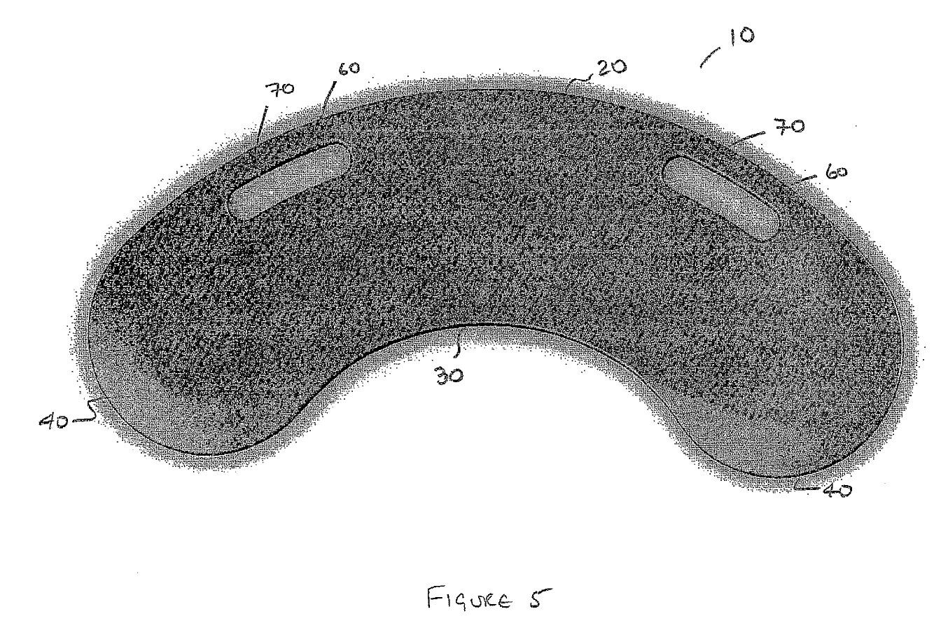

FIG. 5 is a plan view of a transfer device according to the second embodiment;

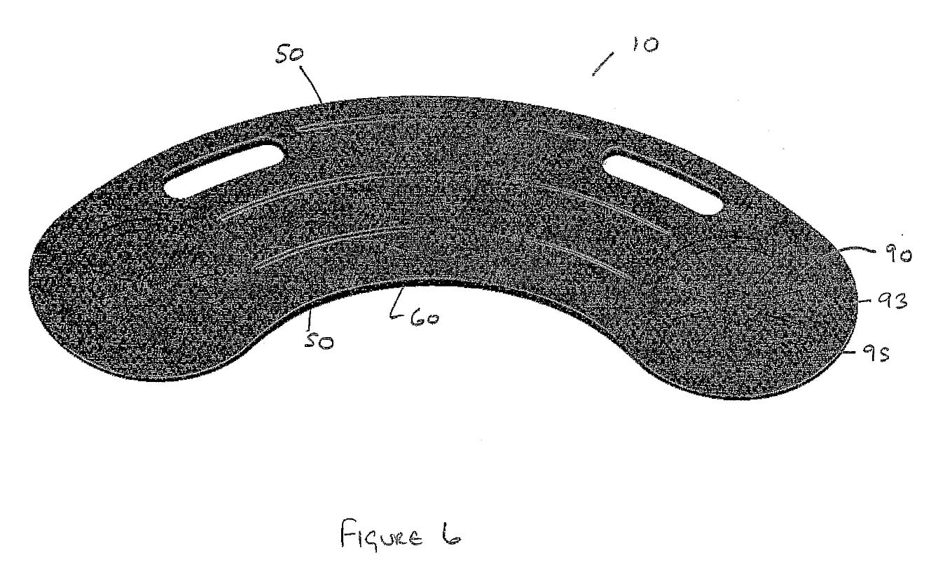

FIG. 6 is a perspective view of the underside of a transfer device according to the second embodiment before fitting of the grip pads; and

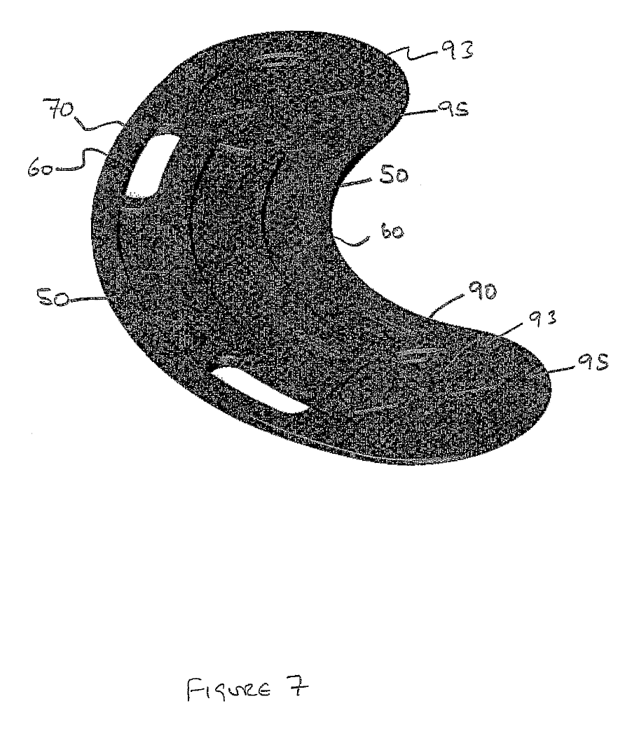

FIG. 7 is a further perspective view of the underside of a transfer device according to the second embodiment before fitting of the grip pads.

According to a first preferred embodiment of the invention, a transfer device 10 is moulded in the shape of an elongate arc, a main portion 11 of the device being bent through an angle of substantially 100°, the device having two major edges in the form of an outer radial edge 20 and an inner radial edge 30. The main portion 11 of the device is shown in defined in FIG. 1 as the portion between lines X-X and Y-Y, The angle between the lines X-X and Y-Y is substantially 100°, being the angle through which the main portion 11 of the device is curved.

Opposite ends 11A, 11B of the device are of a semicircular profile in plan view. The overall device 10 has a smooth outer contour in plan view, as shown in FIG. 1. The absence of sharp or abrupt edges enhances a level of comfort of a user of the device.

Referring now to FIG. 2, the edge 35 of the upper surface 12 of the device, along the entire perimeter of the device, is shaped so as to improve the comfort and ease with which a patient may be manipulated onto the device 10. Thus, the edge 35 has a smooth tapered profile, and smoothly tapered portions 40 at opposite ends 11A, 11B of the device. In embodiments of the invention the edge 35 is of a bevelled profile.

In order to provide enhanced strength to the device 10, and to reduce the weight of the device 10, a series of ribs 50 are moulded into the underside of the device 10 (FIG. 3), running along a portion of a length of the device 10. A device 10 according to the first embodiment can readily support a person having a weight of 250 kg, the board having a length along the line A-A (FIG. 1) of 750 mm, and a thickness variation between 6 mm at the thinnest portion (at opposite ends of the device) and 12 mm at the thickest portion,

The ribs 50 are formed such that the contour between a rib 50 and the remaining underside 60 of the device 10 is smooth. This feature facilitates cleaning of the device 10 if the device 10 becomes soiled.

The device 10 comprises a board 15 fabricated from a moulded talc-filled polypropylene. This material provides a high strength to weight ratio. In addition, a silver-based antimicrobial agent is mixed in with the polypropylene. This aids in keeping the board in an hygienic condition.

At each end of the board 15, on the underside of the board 15, grip pads 80 are provided to aid in maintaining the board in a stable position whilst a patient is being manipulated. The grip pads 80 are located in moulded recesses 90 of the underside of the board 15 (see also FIG. 6 and FIG. 7) to aid in holding the grip pads 80 firmly attached to the board 15. The pads 80 are made from a high-friction material such as rubber.

In the first embodiment, a handle 60 is provided at a location of the device 10 about one third of the length of the device 10 from one end, close to the outer radial edge 20 of the device 10. The handle 60 is in the form of an elongate arcuate aperture 70. The aperture 70 is formed substantially parallel to the outer radial edge 20 of the device 10. The profile of the aperture 70 is of a curved form to minimise stress concentration at sharp corners. In alternate embodiments the handle is provided in different locations along a perimeter of the board or in a central region of the board.

In a second embodiment of the invention (FIG. 4, FIG. 5), two handles 60 are provided, located at positions one third of the length of the device 10 from opposite ends. The presence of two handles 60 allows a further decrease in the weight of the device 10, as well as enhancing portability of the device 10.

The moulded recesses 90 are shown in FIG. 6 and FIG. 7 with the rubber pads removed. The moulded recesses 90 comprise a plurality of further recesses 93, the recesses 90 having radial ribbing 95, to further reduce the weight of the board without an excessive decrease in the strength of the board.

In a third embodiment of the invention, the device does not have carrying handles.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A transfer device for facilitating transfer of a person from one seating position to another, the device comprising an arcuate board at least a main part of which is curved through an angle of at least substantially 70°.

2. A device as claimed in claim 1 further comprising curved end portions, said end portions being provided at longitudinally opposed ends of the main part of the body.

3. A device as claimed in claim 2 wherein said end portions are substantially semicircular in plan view.

4. A device as claimed in claim 1 wherein at least a portion of a perimeter of the device is of a tapered or chamfered cross-section, said portion being configured to allow a person to slide on to or off the device.

5. A device as claimed in claim 3 wherein the perimeter of the device at one of said ends comprises a tapered or chamfered portion,

6. A device as claimed in claim 1 wherein the device is provided with grip means on an underside of the device, the grip means being configured to grip a surface underlying the device.

7. A device as claimed in claim 6 wherein the grip means comprises at least one grip pad.

8. A device as claimed in claim 7 wherein a grip pad is provided at each end of the device.

9. A device as claimed in claim 7 wherein the grip pad comprises a polymeric material.

10. A device as claimed in claim 9 wherein the polymeric material comprises a resilient polymeric material.

11. A device as claimed in claim 9 wherein the polymeric material comprises a rubber material.

12. A device as claimed in claim 6 wherein the grip means is mounted in a recess of the device.

13. A device as claimed in claim 1 wherein a major face of the device comprises at least one rib, the rib being configured to increase a failure strength of the board.

14. A device as claimed in claim 13 wherein a transition region is provided between the rib and a portion of the board adjacent the rib, the transition region being provided with a curved profile, said curved profile being configured to facilitate cleaning of the board.

15. A device as claimed in claim 1 having at least one handle, the handle being configured to allow the device to be conveniently carried by a person.

16. A device as claimed in claim 15 wherein the at least one handle is formed integrally with the board.

17. A device as claimed in claim 16 wherein the at least one handle comprises an aperture formed in a face of the board.

18. A device as claimed in claim 17 wherein the aperture is elongate.

19. A device as claimed in claim 15 wherein the handle is formed in a portion of the board between a middle region of the board and an end of the board, the handle comprising an aperture through the board.

20. A device as claimed in claim 15 wherein the handle is formed proximate a perimeter of the device.

21. A device as claimed in claim 1 comprising two major edges, the major edges being substantially parallel.

22. A device as claimed in claim 1 wherein the main portion or the board is curved through an angle of between substantially 70° and substantially 180°.

23. A device as claimed in claim 1 wherein the main portion of the board is curved through an angle of between substantially 90° and substantially 120°.

24. A device as claimed in claim 1 wherein the main portion of the board is curved through an angle of substantially 100°.

25. A device as claimed in claim 1 wherein the device is provided with an antimicrobial agent.

26-28. (canceled)
